(19) United States
(12) Patent Application Publication
(10) Pub. No.: US 2022/0372187 A1
(43) Pub. Date: Nov. 24, 2022

(54) Resin Composition, and Molded Article and Multilayer Structure Each Comprising Same

(71) Applicant: KURARAY CO., LTD., Okayama (JP)

(72) Inventors: Rina Hoshika, Kurashiki-shi, Okayama (JP); Yuji Shimizu, Kurashiki-shi, Okayama (JP)

(73) Assignee: KURARAY CO., LTD., Okayama (JP)

(21) Appl. No.: 17/781,804

(22) PCT Filed: Dec. 25, 2020
(86) PCT No.: PCT/JP2020/048718

§ 371 Date: Jun. 2, 2022

(30) Foreign Application Priority Data
Dec. 27, 2019 (JP) 2019-237771

(51) Int. Cl. C08F 216/06; C08F 210/02; C08K 3/22; C08K 5/098; C08G 69/00; B29C 48/00

(52) U.S. Cl. CPC C08F 216/06; C08F 210/02; C08K 3/22; C08K 5/098; C08G 69/00; B29C 48/022; C08F 2800/10; C08K 2003/2217; B29K 2023/086

(57) ABSTRACT

The present invention relates to a resin composition comprising an ethylene-vinyl alcohol copolymer (A) with an ethylene unit content of 20 mol % or more and 60 mol % or less, a divalent metal hydroxide (B) and a monovalent metal compound (C), wherein a content of the divalent metal hydroxide (B) is 5 ppm or more and 5000 ppm or less, and a mass ratio (C/B) of the amount of the monovalent metal compound (C) in terms of the monovalent metal atom to the amount of the divalent metal hydroxide (B) in terms of the divalent metal atom is 0.025 to 100. Thus, there is provided a resin composition containing an ethylene-vinyl alcohol copolymer having excellent long run property during melt molding and excellent color phase in long-term melt molding.

### TECHNICAL FIELD

The present invention relates to a resin composition containing an ethylene-vinyl alcohol copolymer, as well as a shaped article and a multilayer structure therefrom.

### BACKGROUND ART

Ethylene-vinyl alcohol copolymer (hereinafter, sometimes abbreviated as “EVOH”) is extensively used as packaging materials including a film, a sheet and a container, because it has favorable properties such as excellent oxygen shield ability. These packaging materials are generally molded by melt molding, and EVOH is required to have excellent appearance (with less discoloration such as yellowing) and excellent long run property during melt molding.

Further, EVOH has a large number of highly reactive hydroxyl groups in its molecular structure. Thus, EVOH has problems related to long run property when melt molding is continuously run for a long duration, such as increase of gels and hard spots over time and increase of streak-like poor appearance leading to deterioration of commercial value as a shaped article. Regarding the problems related to long run property such as increase of gels and hard spots and generation of streak-like poor appearance, which problem occurs depends on an equipment and running conditions for molding, and both problems may occur. In any case, it is needed to provide an EVOH resin composition having excellent long run property with less change over time even in continuous operation for a long period.

Patent Reference No. 1 has described a resin composition comprising EVOH as a main component, a phosphorous compound and a metal salt, wherein the phosphorous compound is condensed phosphoric acid, a compound having two or more phosphonate groups or a combination thereof; a content of the phosphorous compound is 0.1 ppm or more and less than 50 ppm; and a content of the metal salt is 5 ppm or more and 500 ppm or less in terms of the metal element. According to the document, there can be provided a resin composition having excellent appearance property and long run property in melt molding and particularly capable of suppressing occurrence of yellowing even after repeated use, and a shaped article produced using such a composition.

### PRIOR ART REFERENCES

PATENT REFERENCES
Patent Reference No. 1: WO2017/110568

### SUMMARY OF THE INVENTION

### Problems to be Solved by the Invention

However, demand for shaped articles regarding color phase and appearance properties (gel, hard spots, streaks and the like) has been increasing in recent years. Although the resin composition comprising a phosphorus compound and a metal salt described in Patent Reference No. 1 has improved long run property, it does not necessarily have sufficient color phase or gas barrier property during long-term melt molding. There have been, therefore, needed to provide a resin composition capable of achieving both excellent color phase during melt molding and excellent long run property during long-term melt molding.

To solve the above problems, an objective of the present invention is to provide a resin composition comprising EVOH, which is excellent in long run property during melt molding and also excellent in color phase during long-term melt molding. Another objective of the present invention is to provide a shaped article and multilayer structure comprising the resin composition.

### MEANS FOR SOLVING THE PROBLEMS

To solve the above problems, the present invention provides a resin composition as described below, and a shaped article and a multilayer structure therewith.

Specifically, the present invention can be achieved by providing

[1] A resin composition comprising an ethylene-vinyl alcohol copolymer (A) (hereinafter, sometimes abbreviated as “EVOH (A)”) with an ethylene unit content of 20 mol % or more and 60 mol % or less, a divalent metal hydroxide (B) and a monovalent metal compound (C), wherein a content of the divalent metal hydroxide (B) is 5 ppm or more and 5000 ppm or less, and a mass ratio (C/B) of the amount of the monovalent metal compound (C) in terms of the monovalent metal atom to the amount of the divalent metal hydroxide (B) in terms of the divalent metal atom is 0.025 to 100;

[2] The resin composition according to [1], further comprising a polyamide resin (D) (hereinafter, sometimes abbreviated as “PA (D)”);

[3] The resin composition according to [2], wherein a mass ratio (A/D) of EVOH (A) to PA (D) is 55/45 to 99/1;

[4] The resin composition according to [2] or [3], comprising a matrix phase containing EVOH (A) and a dispersion phase containing PA (D), wherein an average dispersed particle size of the dispersion phase containing PA (D) is 2 μm or less.

[5] The resin composition according to any of [1] to [4], wherein the ethylene-vinyl alcohol copolymer (A) occupies 95% by mass or more of a thermoplastic resin constituting the resin composition, or the ethylene-vinyl alcohol copolymer (A) and the polyamide resin (D) occupy 95% by mass or more of a thermoplastic resin constituting the resin composition;

[6] The resin composition according to any of [1] to [5], wherein a content of the monovalent metal compound (C) in terms of the monovalent metal atom is 5 ppm or more and 1000 ppm or less;

[7] The resin composition according to any of [1] to [6], wherein the divalent metal atom constituting the divalent metal hydroxide (B) is at least one selected from the group consisting of magnesium, calcium, iron and zinc;

[8] The resin composition according to any of [1] to [7], wherein a proportion of magnesium atoms in the total metal atoms constituting the divalent metal hydroxide (B) is 80 mol % or more;

[9] The resin composition according to any of [1] to [8], wherein the monovalent metal atom constituting the monovalent metal compound (C) is at least one selected from the group consisting of sodium, potassium, lithium, rubidium and cesium;

[10] The resin composition according to any of [1] to [9], further comprising a carboxylic acid;

[11] The resin composition according to [10], wherein the resin composition comprises a higher fatty acid as the carboxylic acid, and a content of the higher fatty acid is 0.1 ppm or more and 250 ppm or less;

[12] The resin composition according to any of [1] to [11], further comprising a phosphate compound;

[13] The resin composition according to any of [1] to [12], wherein an aspect ratio of the divalent metal hydroxide (B) is 3 or more and 500 or less;

[14] A shaped article comprising the resin composition according to any of [1] to [13]; and

[15] A multilayer structure comprising a layer made of the resin composition according to any of [1] to [13].

### Effects of the Invention

According to the present invention, there can be provided a resin composition comprising EVOH, which has excellent long run property during melt molding and excellent color phase during long-term melt molding.

### MODES FOR CARRYING OUT THE INVENTION

A resin composition of the present invention comprises EVOH (A) with an ethylene unit content of 20 mol % or more and 60 mol % or less, a divalent metal hydroxide (B) and a monovalent metal compound (C), wherein a content of the divalent metal hydroxide (B) is 5 ppm or more and 5000 ppm or less, and a mass ratio (C/B) of the amount of the monovalent metal compound (C) in terms of the monovalent metal atom to the amount of the divalent metal hydroxide (B) in terms of the divalent metal atom is 0.025 to 100. When these requirements are satisfied, there can be provided a resin composition having excellent long run property during melt molding and excellent color phase during long-term melt molding.

### EVOH (A)

A resin composition of the present invention, which contains EVOH (A), tends to have excellent gas barrier property. EVOH (A) contained in a resin composition of the present invention is a copolymer mainly consisting of ethylene units and vinyl alcohol units, which is produced by saponifying vinyl ester units in an ethylene-vinyl ester copolymer. EVOH (A) used in the present invention can be, but not limited to, those known for the use in melt molding. EVOH (A) can be used alone or in combination of two or more.

An ethylene unit content of EVOH (A) is 20 mol % or more and 60 mol % or less. If the ethylene unit content is less than 20 mol %, melt molding property of the resin composition may be deteriorated, and thus it is preferably 24 mol % or more, more preferably 26 mol % or more. If the ethylene unit content is more than 60 mol %, gas barrier property may be deteriorated, and thus, it is preferably 48 mol % or less, more preferably 46 mol % or less.

A saponification degree of EVOH (A) is, but not limited to, preferably 95 mol % or more, more preferably 98 mol % or more, further preferably 99 mol % or more in the light of maintaining gas barrier property and exerting long run property. Meanwhile, the upper limit of a saponification degree of EVOH (A) is preferably 100 mol %, more preferably 99.99 mol %. A saponification degree is determined in accordance with JIS K6726.

The lower limit of a melt flow rate (determined under the conditions of a temperature of 210° C. and a load of 2160 g in accordance with a method described in ASTM D1238; hereinafter, “melt flow rate” is sometimes abbreviated as “MFR”) of EVOH (A) is preferably 0.5 g/10 min, more preferably 1.0 g/10 min, further preferably 2.0 g/10 min. Meanwhile, the upper limit of an MFR is preferably 100 g/10 min, more preferably 50 g/10 min, further preferably 25 g/10 min. When an MFR is within the above range, moldability and processability of a resin composition are improved.

EVOH (A) can contain units derived from a monomer other than ethylene, a vinyl ester and a saponified product thereof. When EVOH (A) contains the above-described other monomer units, a content of the other monomer units based on the total structural units of EVOH (A) is preferably 30 mol % or less, more preferably 20 mol % or less, further preferably 10 mol % or less, particularly preferably 5 mol % or less. When EVOH (A) has units derived from the above-described other monomer, the lower limit thereof can be 0.05 mol % or 0.10 mol %. Examples of the other monomer include alkenes such as propylene, butylene, pentene, and hexene; alkenes having an ester group or a saponified product thereof such as 3-acyloxy-1-propene, 3-acyloxy-1-butene, 4-acyloxy-1-butene, 3,4-diacyloxy-1-butene, 3-acyloxy-4-methyl-1-butene, 4-acyloxy-2-methyl-1-butene, 4-acyloxy-3-methyl-1-butene, 3,4-diacyloxy-2-methyl-1-butene, 4-acyloxy-1-pentene, 5-acyloxy-1-pentene, 4,5-diacyloxy-1-pentene, 4-acyloxy-1-hexene, 5-acyloxy-1-hexene, 6-acyloxy-1-hexene, 5,6-diacyloxy-1-hexene and 1,3-diacetoxy-2-methylenepropane, unsaturated acids or anhydrides, salts or mono- or di-alkyl esters thereof such as acrylic acid, methacrylic acid, crotonic acid and itaconic acid; nitriles such as acrylonitrile and methacrylonitrile; amides such as acrylamide and methacrylamide; olefinic sulfonic acids or salts thereof such as vinylsulfonic acid, allylsulfonic acid and methallyl sulfonic acid; vinylsilanes such as vinyltrimethoxysilane, vinyltriethoxysilane, vinyltri(β-methoxy-ethoxy)silane, and y-methacryloxypropylmethoxysilane; alkyl vinyl ethers; vinyl ketone; N-vinylpyrrolidone; vinyl chloride; and vinylidene chloride. EVOH (A) may be post-modified by a method such as urethanization, acetalization, cyanoethylation, or oxyalkylenation.

EVOH (A) can be produced by producing an ethylene-vinyl ester copolymer in accordance with, for example, a known method followed by saponification. The ethylene-vinyl ester copolymer can be produced by polymerizing, for example, ethylene and a vinyl ester in an organic solvent such as methanol, t-butyl alcohol and dimethylsulfoxide under pressure in the presence of a radical polymerization initiator such as benzoyl peroxide and azobisisobutyronitrile. Examples of a vinyl ester which can be used as a starting material include vinyl acetate, vinyl propionate and vinyl pivalate, and among these, vinyl acetate is preferable. An acid or alkali catalyst can be used for saponifying the ethylene-vinyl ester copolymer. Saponification can be conducted in either continuous style or batch style. Examples of an alkali catalyst which can be used include sodium hydroxide, potassium hydroxide and an alkali-metal alcoholate.

Thus, a solution containing EVOH (A) is prepared, and a solvent is then removed. A solvent can be removed by any method as long as it can reduce a content of the solvent. The EVOH solution is extruded into a poor solvent such as water to induce coagulation, so that a content of the solvent can be reduced, causing solidification. Alternatively, water can be mechanically squeezed out in an extruder or a kneader, or steam can be evaporated from a vent. After thus removing the solvent, a remaining mass can be cut into EVOH (A) pellets. There are no particular restrictions to a method for producing EVOH (A) pellets by cutting. A solidified water-containing strand can be cut with a cutter. Alternatively, a fluid state of strand with a reduced water content in an extruder or kneader can be cut with a hot cutter or underwater cutter.

### Divalent Metal Hydroxide (B)

The resin composition of the present invention contains 5 ppm or more and 5000 ppm or less of a divalent metal hydroxide (B). A content of the divalent metal hydroxide (B) is preferably 10 ppm or more, more preferably 15 ppm or more, still more preferably 20 ppm or more. If a content of the divalent metal hydroxide (B) is less than 5 ppm, the long run property during melt molding tends to be deteriorated. A content of the divalent metal hydroxide (B) is preferably 3000 ppm or less, more preferably 2500 ppm or less, further preferably 1500 ppm or less, and particularly preferably 400 ppm or less. If a content of the divalent metal hydroxide (B) is more than 5000 ppm, color phase tends to be deteriorated in long-term melt molding.

When a resin composition of the present invention does not contain PA (D) described later, a content of the divalent metal hydroxide (B) in the resin composition of the present invention is preferably 10 ppm or more, more preferably 15 ppm or more, further preferably 20 ppm or more in the light of long run property during melt molding. When a resin composition of the present invention does not contain PA (D) described later, a content of the divalent metal hydroxide (B) is preferably 1500 ppm or less, more preferably 1100 ppm or less, further preferably 400 ppm or less in the light of color phase in long-term melt molding. When a resin composition of the present invention does not contain PA (D) described later, the use of a fatty acid divalent metal salt such as an acetic acid divalent metal salt instead of the divalent metal hydroxide (B) tends to deteriorate color phase.

When the resin composition of the present invention contains PA (D) described later, a content of the divalent metal hydroxide (B) is preferably 30 ppm or more, more preferably 50 ppm or more, further preferably 70 ppm or more in the light of long run property during melt molding. In the light of color phase in long-term melt molding, a content of the divalent metal hydroxide (B) is preferably 3500 ppm or less, more preferably 2800 ppm or less, further preferably 1100 ppm or less, particularly preferably 500 ppm or less. When the resin composition of the present invention contains PA (D) described later, the use of a carboxylic acid divalent metal salt such as an acetic acid divalent metal salt instead of the divalent metal hydroxide (B) tend to deteriorate appearance after retort treatment.

In the resin composition of the present invention, a content of the divalent metal hydroxide (B) in terms of divalent metal atom is preferably 2 ppm or more and 3500 ppm or less. With the content in terms of divalent metal atom being within the above range, long run property during melt molding is excellent, and color phase tends to be excellent in long-term melt molding. The content in terms of divalent metal atom is preferably 4 ppm or more, more preferably 6 ppm or more, further preferably 8 ppm or more. Furthermore, the content in terms of divalent metal atom is preferably 1500 ppm or less, more preferably 1000 ppm or less, further preferably 400 ppm or less.

When the resin composition of the present invention does not contain PA

(D) described later, the content in terms of divalent metal atom is preferably 2 ppm or more and 2000 ppm or less. With the content in terms of divalent metal atom being within the above range, long run property during melt molding is excellent, and color phase tends to be excellent in long-term melt molding. The content in terms of divalent metal atom is preferably 4 ppm or more, more preferably 6 ppm or more, further preferably 8 ppm or more. On the other hand, the content in terms of divalent metal atom is preferably 1500 ppm or less, more preferably 600 ppm or less, further preferably 100 ppm or less.

When the resin composition of the present invention contains PA (D) described later, the content in terms of divalent metal atom is preferably 12 ppm or more, more preferably 20 ppm or more, further preferably 32 ppm or more. On the other hand, the content in terms of divalent metal atom is preferably 1400 ppm or less, more preferably 1100 ppm or less, further preferably 450 ppm or less, particularly preferably 200 ppm or less.

An aspect ratio of the divalent metal hydroxide (B) is, but not limited to, preferably 3 or more and 500 or less. An aspect ratio of the divalent metal hydroxide (B) is more preferably 8 or more, further preferably 12 or more, particularly preferably 25 or more. Meanwhile, an aspect ratio of the divalent metal hydroxide (B) is more preferably 400 or less, further preferably 300 or less, particularly preferably 100 or less. With an aspect ratio of the divalent metal hydroxide (B) being within the above range, gas barrier property under higher humidity tends to be favorable. It is not known exactly why such a tendency occurs, but it is a peculiar tendency which is not found from gas barrier property evaluation under low humidity. An aspect ratio is a value obtained from an arithmetic mean of measured values of a primary particle width (major axis) and a primary particle thickness (minor axis) of any 100 crystals in an SEM photograph by an SEM method.

There are no particular restrictions to a divalent metal atom constituting the divalent metal hydroxide (B), but it is preferable that at least one selected from the group consisting of magnesium, calcium, iron and zinc is contained. Among these, in the light of long run property in long-term melt molding, a divalent metal atom constituting the divalent metal hydroxide (B) is preferably at least one selected from the group consisting of magnesium, calcium and zinc, further preferably at least one selected from the group consisting of magnesium and calcium, particularly preferably magnesium.

Examples of the divalent metal hydroxide (B) include hydroxides containing the above divalent metal atom, preferably at least one selected from the group consisting of magnesium hydroxide, calcium hydroxide, iron hydroxide and zinc hydroxide. Among these, in the light of long run property in long-term melt molding, it is more preferably at least one selected from the group consisting of magnesium hydroxide, calcium hydroxide and zinc hydroxide, further preferably at least one selected from the group consisting of magnesium hydroxide and calcium hydroxide, particularly preferably magnesium hydroxide.

A proportion of at least one selected from the group consisting of magnesium, calcium and zinc in the total metal atoms constituting the divalent metal hydroxide (B) is preferably 80 mol % or more, more preferably 90 mol % or more, further preferably 95 mol % or more, and it is particularly preferable that metal atoms constituting the divalent metal hydroxide (B) substantially consist of one kind of metal atoms selected from the group consisting of magnesium, calcium and zinc, which endows advantage of excellent long run property in long-term melt molding. In particular, a proportion of magnesium atoms in the total metal atoms constituting the divalent metal hydroxide (B) is preferably 80 mol % or more, more preferably 90 mol % or more, further preferably 95 mol % or more, and it is particularly preferable that metal atoms constituting the divalent metal hydroxide (B) substantially consist of magnesium atoms. With a proportion of magnesium atoms being 80 mol % or more, long run property in long-term melt molding tends to be particularly excellent.

### Monovalent Metal Compound (C)

A resin composition of the present invention contains a monovalent metal compound (C), wherein a mass ratio (C/B) of the amount of the monovalent metal compound (C) in terms of the monovalent metal atom to the amount of the divalent metal hydroxide (B) in terms of the divalent metal atom is 0.025 to 100. The mass ratio C/B is preferably 0.2 or more, more preferably 1.0 or more, further preferably 1.5 or more, particularly preferably 2.0 or more. If the mass ratio C/B is less than 0.025, long run property during melt molding tends to be deteriorated. The mass ratio C/B is preferably 80 or less, more preferably 60 or less, further preferably 50 or less, particularly preferably 30 or less. If the mass ratio C/B is more than 100, color phase in long-term melt molding tends to be deteriorated.

When a resin composition of the present invention does not contain PA (D) described later, a mass ratio C/B is preferably 0.05 or more, more preferably 0.2 or more, further preferably 0.3 or more, particularly preferably 1.2 or more, most preferably 2.5 or more. The mass ratio C/B is preferably 80 or less, more preferably 60 or less, further preferably 50 or less. If the mass ratio C/B is more than 100, color phase in long-term melt molding tends to be deteriorated.

When a resin composition of the present invention contains PA (D) described later, a mass ratio C/B is preferably 0.05 or more, more preferably 0.2 or more, further preferably 0.3 or more, particularly preferably 1.2 or more, most preferably 2.0 or more. The mass ratio C/B is preferably 80 or less, more preferably 60 or less, further preferably 50 or less. If the mass ratio C/B is more than 100, color phase in long-term melt molding tends to be deteriorated.

A content of the monovalent metal compound (C) in terms of the monovalent metal atom in a resin composition of the present invention is preferably 5 ppm or more, more preferably 30 ppm or more, further preferably 50 ppm or more, particularly preferably 80 ppm or more. When the content in terms of the monovalent metal atom is 5 ppm or more, long run property during melt molding tends to be favorable. The content in terms of the monovalent metal atom is preferably 1000 ppm or less, more preferably 750 ppm or less, further preferably 500 ppm or less, particularly preferably 250 ppm or less. If the content in terms of the monovalent metal atom is 1000 ppm or less, deterioration of color phase in long-term melt molding tends to be inhibited.

A monovalent metal atom constituting a monovalent metal compound (C) is preferably, but not limited to, at least one selected from the group consisting of sodium, potassium, lithium, rubidium and cesium. Among these, in the light of long run property during melt molding, a monovalent metal atom constituting the monovalent metal compound (C) is further preferably at least one selected from the group consisting of sodium and potassium, particularly preferably sodium.

Specific examples of the monovalent metal compound (C) include salts of an organic acid such as an aliphatic carboxylic acid, an aromatic carboxylic acid, an aliphatic dicarboxylic acid, an aromatic dicarboxylic acid, a tricarboxylic acid, a tetracarboxylic acid, a hydroxycarboxylic acid, a ketodicarboxylic acid and an amino acid, containing the monovalent metal atom; salts of an inorganic acid such as sulfuric acid, sulfurous acid, carbonic acid and phosphoric acid; and metal complexes. Examples include sodium acetate, potassium acetate, sodium phosphate, lithium phosphate, sodium stearate, potassium stearate, and ethylenediaminetetraacetic acid sodium salt. Among these, preferred is at least one selected from the group consisting of sodium acetate, potassium acetate and sodium phosphate.

### Carboxylic Acid

A resin composition of the present invention preferably contains a carboxylic acid. The carboxylic acid is preferably at least one selected from the group consisting of lower fatty acids having 1 to 7 carbon atoms and higher fatty acids having 8 to 30 carbon atoms, and more preferably, both the lower fatty acid and the higher fatty acid are contained. Examples of a lower fatty acid includes oxalic acid, succinic acid, benzoic acid, citric acid, acetic acid and lactic acid. Among these, acetic acid is preferable in the light of cost and availability. Examples of a higher fatty acid having 8 to 30 carbon atoms include stearic acid, lauric acid, montanic acid, behenic acid, octylic acid, sebacic acid, recinoleic acid, myristic acid and palmitic acid. Among these, stearic acid is preferable in the light of dispersibility.

A content of a carboxylic acid contained in a resin composition of the present invention is preferably, but not limited to, 0.1 ppm or more 2000 ppm or less. With a content of the carboxylic acid being within the above range, deterioration of color phase in long-term melt molding can be advantageously inhibited. In particular, a content of the above lower fatty acid is more preferably 10 ppm or more, further preferably 30 ppm or more, particularly preferably 50 ppm or more, most preferably 80 ppm or more. Meanwhile, a content of the above lower fatty acid is more preferably 1500 ppm or less, further preferably 1000 ppm or less, particularly preferably 500 ppm or less.

A resin composition of the present invention contains a higher fatty acid as the above carboxylic acid, and a content of the higher fatty acid is preferably 0.1 ppm or more and 250 ppm or less. With a content of the higher fatty acid being within the above range, dispersibility of the divalent metal hydroxide (B) is advantageously improved. A content of the higher fatty acid is more preferably 0.2 ppm or more, further preferably 0.5 ppm or more, particularly preferably 1 ppm or more. Meanwhile, a content of the higher fatty acid is more preferably 200 ppm or less, further preferably 100 ppm or less, particularly preferably 50 ppm or less.

### Phosphate Compound

A resin composition of the present invention preferably contains a phosphate compound. Examples of a phosphate compound include various acids such as phosphoric acid and phosphorous acid and salts thereof. A phosphate salt can be contained as any of monobasic phosphate, dibasic phosphate or tribasic phosphate, and a counter cation is preferably, but not limited to, an alkali metal or an alkaline earth metal. Among these, a phosphorous compound is preferably added as sodium dihydrogen phosphate, potassium dihydrogen phosphate, disodium hydrogen phosphate or dipotassium hydrogen phosphate.

A content of a phosphate compound contained in a resin composition of the present invention is preferably, but not limited to, 1 ppm or more and 1000 ppm or less in terms of phosphoric acid radical. With a content of the phosphate compound being within the above range, deterioration of color phase in long-term melt molding can be advantageously inhibited. A content of the phosphate compound is more preferably 3 ppm or more, further preferably 5 ppm or more, particularly preferably 10 ppm or more. Meanwhile, a content of the phosphate compound is more preferably 800 ppm or less, further preferably 500 ppm or less, particularly preferably 300 ppm or less.

### PA (D)

In a preferable aspect, a resin composition of the present invention contains PA (D). The presence of PA (D) has effects of excellent long run property during melt molding, excellent color phase in long-term melt molding and excellent appearance even after hot-water treatment such as retort treatment (retort resistance). Examples of PA (D) include polycaproamide (Nylon 6), poly-w-aminoheptanoic acid (Nylon 7), poly-w-aminononanoic acid (Nylon 9), polyundecaneamide (Nylon 11), polylauryl lactam (Nylon 12), polyethylenediamine adipamide (Nylon 26), polytetramethylene adipamide

(Nylon 46), polyhexamethylene adipamide (Nylon 66), polyhexamethylene sebacamide (Nylon 610), polyhexamethylene dodecamide (Nylon 612), polyoctamethylene adipamide (Nylon 86), polydecamethylene adipamide (Nylon 106), caprolactam/lauryllactam copolymer (Nylon 6/12), caprolactam/w-aminononanoic acid copolymer (Nylon 6/9), caprolactam/hexamethylene diammonium adipate copolymer (Nylon 6/66), lauryl lactam/hexamethylene diammonium adipate copolymer (Nylon 12/66), ethylene diammonium adipate/hexamethylenediammonium adipate copolymer (Nylon 26/66), caprolactam/hexamethylenediammonium adipate/hexamethylenediammonium sebacate copolymer (Nylon 6/66/610), ethylenediammonium adipate/hexamethylenediammonium adipate/hexamethylenediammonium sebacate copolymer (Nylon 26/66/610), polyhexamethylene isophthalamide (Nylon 61), polyhexamethylene terephthalamide (Nylon 6T), hexamethylene isophthalamide/hexamethylene terephthalamide copolymer (Nylon 61/6T), 11-aminoundecaneamide/hexamethylene terephthalamide copolymer, polynonamethylene terephthalamide (Nylon 9T), polydecamethylene terephthalamide (Nylon 10T), polyhexamethylene cyclohexylamide, polynonamethylene cyclohexylamide, and these polyamides modified with an aromatic amine such as methylenebenzylamine and metaxylenediamine. Metaxylylenediammonium adipate is also another example.

Among these, in the light of improving appearance after hot-water treatment such as retort treatment, it is preferably a polyamide resin mainly made of caproamide. Specifically, 75 mol % or more of the constituent units of PA (D) is preferably a caproamide unit. Among these, in the light of compatibility with EVOH (A), PA (D) is preferably Nylon 6.

There are no particular restrictions to a method for polymerizing PA(D), and a known method can be employed, including melt polymerization, interfacial polymerization, solution polymerization, bulk polymerization, solid phase polymerization, and a combination thereof.

When a resin composition of the present invention contains PA (D), a mass ratio (A/D) of EVOH (A) to PA (D) is preferably 55/45 to 99/1. If the mass ratio (A/D) is less than 55/45, color phase may be deteriorated in long-term melt molding, and it is more preferably 60/40 or more, further preferably 70/30 or more, particularly preferably 80/20 or more. If the mass ratio (A/D) is more than 99/1, appearance after hot-water treatment such as retort treatment may be insufficient, and it is more preferably 95/5 or less.

When a resin composition of the present invention contains PA (D), the resin composition preferably contains a matrix phase containing EVOH (A) and a dispersion phase containing PA (D), wherein an average dispersed particle size of the dispersion phase containing PA (D) is 2 μm or less. An average dispersed particle size of the dispersion phase containing PA (D) means an average dispersed particle size of the dispersion phase dispersed in EVOH (A) as the matrix phase. Although a dispersion phase is substantially made of PA (D) alone, the dispersion phase may contain a resin other than PA (D). A content of the resin other than PA (D) in the dispersion phase is generally 50% by mass or less. Here, an average dispersed particle size is determined by calculating an average of particle sizes measured from observation of 100 of dispersion phases containing PA (D) within a field of view by means of an electron microscope. When a particle has a shape other than a sphere such as an oval, an average is calculated for a long diameter. When an average dispersed particle size of the dispersion phase containing PA (D) is 2 μm or less, appearance after retort treatment tends to be excellent, and the average dispersed particle size is more preferably 1 μm or less, further preferably 0.5 μm or less, particularly 0.2 μm or less. An average dispersed particle size of the dispersion phase containing PA (D) can be 0.01 μm or more. A dispersed particle size of PA (D) can be adjusted within a suitable range by varying an addition method or an addition order of EVOH (A), a divalent metal hydroxide (B), a monovalent metal compound (C) and PA (D), a resin temperature during kneading, a screw structure, a screw frequency and a residence time.

Although in a suitable embodiment a thermoplastic resin constituting a resin composition of the present invention contains the above PA (D) in addition to EVOH (A), other thermoplastic resins other than EVOH (A) or PA (D) can be contained as long as the effects of the present invention are not impaired. Examples of the other thermoplastic resin include polyolefins; polyestetrs; polystyrenes; polyvinyl chlorides; acrylic resins; polyurethanes; polycarbonates;

and polyvinyl acetates. A content of the other thermoplastic resin is generally less than 5% by mass. When a resin composition of the present invention does not contain PA (D), a thermoplastic resin constituting a resin composition of the present invention is constituted with EVOH (A) preferably in 90% by mass or more, more preferably in 97% by mass or more, further preferably in 99% by mass or more, particularly preferably substantially alone in the light of higher effects of gas barrier property derived from EVOH (A). When a resin composition of the present invention contains PA (D), a thermoplastic resin constituting a resin composition of the present invention is constituted with EVOH (A) and PA (D) preferably in 95% by mass or more, more preferably in 97% by mass or more, further preferably in 99% by mass or more, particularly preferably substantially 100% in the light of improving appearance property after retort treatment.

A resin composition of the present invention can contain a variety of additives other than those described above as long as they do not impair the effects of the present invention. Examples of such additives include an antioxidant, a plasticizer, a heat stabilizer, a UV absorber, an antistatic, a lubricant, a colorant, a filler and other resins, and specific examples are described below. A content of additives is generally 10% by mass or less, suitably 5% by mass or less, more suitably 1% by mass or less.

Antioxidant: 2,5-di-t-butylhydroquinone, 2,6-di-t-butyl-p-cresol, 4,4′-thiobis(6-t-butylphenol), 2,2′-methylene-bis(4-methyl-6-t-butylphenol), octadecyl-3-(3′,5′-di-t-butyl-4′-hydroxyphenyl)propionate, 4,4′-thiobis(6-t-butylphenol) and the like.

Plasticizer: diethyl phthalate, dibutyl phthalate, dioctyl phthalate, wax, liquid paraffin, phosphates and the like.

Ultraviolet absorber: ethylene-2-cyano-3,3′-diphenyl acrylate, 2-(2′-hydroxy-5′-methylphenyl)benzotriazole, 2-(2′-hydroxy-5′-methylphenyl)benzotriazole, 2-(2′-hydroxy-3′-t-butyl-5′-methylphenyl)5-chlorobenzotriazole, 2-hydroxy-4-methoxybenzophenone, 2,2′-dihydroxy-4-methoxybenzophenone and the like.

Antistatic agent: pentaerythritol monostearate, sorbitan monopalmitate, sulfated polyolefins, polyethylene oxide and the like.

Lubricant: ethylene-bis-stearamide, butyl stearate and the like.

When a resin composition of the present invention does not contain PA (D), in the resin composition of the present invention, EVOH (A), a divalent metal hydroxide (B) and a monovalent metal compound (C) occupy preferably 95% by mass or more, more preferably 98% by mass or more, further preferably 99% by mass or more and particularly preferably, the resin composition of the present invention substantially consists of EVOH (A), the divalent metal hydroxide (B) and the monovalent metal compound (C). When a resin composition of the present invention contains PA (D), in the resin composition of the present invention, EVOH (A), a divalent metal hydroxide (B), a monovalent metal compound (C) and PA (D) occupy preferably 95% by mass or more, more preferably 98% by mass or more, further preferably 99% by mass or more and particularly preferably, the resin composition of the present invention substantially consists of EVOH (A), the divalent metal hydroxide (B), the monovalent metal compound (C) and PA (D).

There are no particular restrictions to a method for preparing a resin composition of the present invention, but it is preferably prepared by adding various additives such as a divalent metal hydroxide (B), a monovalent metal compound (C), and a carboxylic acid to EVOH (A) followed by melt-kneading. When PA (D) is contained, it is preferably prepared by dry-blending EVOH (A) and PA (D) followed by melt-kneading. Specifically, melt-kneading can be conducted using a known mixing or kneading device such as a kneader ruder, an extruder, a mixing roll and a Banbury mixer. A temperature during melt-kneading is generally 110 to 300° C. The divalent metal hydroxide (B), monovalent metal compound (C) and the various additives can be preliminarily added to EVOH (A) or PA (D).

A resin composition of the present invention can have any shape such as pellets and powder, preferably pellets in the light of stable melt molding. When EVOH (A) is pellets, the composition can be prepared suitably by a method comprising immersing the EVOH (A) pellets into a solution containing various additives such as a monovalent metal compound (C) and a carboxylic acid, drying the pellets to give dried EVOH (A) pellets, and dry-blending the pellets with a divalent metal hydroxide (B). In the light of preventing troubles during melt molding, a moisture content of the dried EVOH (A) pellets is preferably 1% by mass or less, more preferably 0.5% by mass or less. When a lower fatty acid having 1 to 7 carbons or a higher fatty acid having 8 to 30 carbon atoms is used as a carboxylic acid, it is preferable that the solution contains the lower fatty acid, and it is preferable that the higher fatty acid is added during dry-blending the dried EVOH (A) pellets and the divalent metal hydroxide (B).

Applications of a resin composition of the present invention include an extruded article, a film or sheet (in particular, a stretched film or heat-shrinking film), a thermoformed article, a wall paper or decorative plate, a pipe or hose, a deformed shaped article, an extrusion blow-molded article, an injection molded article, a flexible packaging material, and a container (in particular, a retort container). When the shaped article is a multilayer structure, preferred are a coextruded film or coextruded sheet, a heat shrinkable film, a container (in particular, a coextruded blow-molded container, a co-injection molded container, a retort container), a pipe (in particular, a fuel pipe or pipe for hot water circulation), and a hose (in particular, a fuel hose) and the like.

When the shaped article of the present invention is a multilayer structure containing a resin composition of the present invention, such a multilayer structure is formed by laminating other layers different from the layer made of the resin composition of the present invention. Examples of a layer configuration of the multilayer structure the present invention include x/y, x/y/x, x/z/y, x/z/y/z/x, x/y/x/y/x, and x/z/y/z/x/z/y/z/x, where x represents a layer made of a polymer other than a resin composition of the present invention, y represents a layer made of a resin composition of the present invention, and z represents an adhesive polymer layer. When a plurality of x layers are formed, they can be the same type or different types. Furthermore, a layer made of a recovered polymer consisting of a scrap including trims generated during molding can be separately formed, or the recovered polymer can be blended into a layer made of another polymer. There are no particular restrictions to thicknesses of individual layers in the multilayer structure, but in the light of moldability, cost and the like, a ratio of a thickness of y layer to the total layer thickness is preferably 2 to 20%.

A polymer used for the x layer is preferably a thermoplastic polymer in the light of processability and so on. Examples of such a thermoplastic polymer include the following polymers.
polyethylene, polypropylene, ethylene-propylene copolymer, and ethylene or propylene copolymers (copolymer of ethylene or propylene with at least one selected from the followings: α-olefins such as 1-butene, isobutene, 4-methyl-1-pentene, 1-hexene and 1-octene; unsaturated carboxylic acids or salts, partial esters or complete esters, nitriles, amides and anhydrides thereof such as itaconic acid, methacrylic acid, acrylic acid and maleic anhydride; vinyl carboxylates such as vinyl formate, vinyl acetate, vinyl propionate, vinyl butyrate, vinyl octanoate, vinyl dodecanoate, vinyl stearate and vinyl arachidonate; vinylsilane compounds such as vinyltrimethoxysilane; unsaturated sulfonic acids or salts thereof; alkylthiols; vinylpyrrolidones and the like);
polyolefins such as poly4-methyl-1-pentene and poly1-butene;
polyesters such as polyethylene terephthalate, polybutylene terephthalate, and polyethylene naphthalate;
polyamides such as polys-caprolactam, polyhexamethylene adipamide and polymethaxylylene adipamide;
polyvinylidene chloride, polyvinyl chloride, polystyrene, polyacrylonitrile, polycarbonate and polyacrylate, and the like.

Such a thermoplastic polymer layer can be non-stretched, or uniaxially or biaxially stretched, or rolled.

Among these thermoplastic polymers, polyolefins are preferable in terms of moisture resistance, mechanical properties, economy, heat sealability and the like, and polyamides and polyesters are preferable in terms of mechanical properties, heat resistance and the like.

Meanwhile, an adhesive polymer used for the z layer can be any adhesive polymer which is capable of adhering between the layers; preferably, a polyurethane-based or polyester-based one-component or two-component curable adhesive, a carboxylic acid-modified polyolefin polymer and the like. A carboxylic acid-modified polyolefin polymer is an olefinic polymer or copolymer containing an unsaturated carboxylic acid or anhydride thereof (maleic anhydride, etc.) as a copolymerizing component; or a graft copolymer prepared by grafting an unsaturated carboxylic acid or anhydride thereof to an olefinic polymer or copolymer.

When a multilayer structure is produced by a co-injection molding method, a co-extrusion molding method or the like, the adhesive polymer is more preferably a carboxylic acid-modified polyolefin polymer. In particular, when the x layer is a polyolefin polymer, adhesiveness to the y layer is favorable. Examples of the polyolefin polymer constituting such a carboxylic acid-modified polyolefin polymer include polyethylenes such as low-density polyethylene (LDPE), linear low-density polyethylene (LLDPE), and ultra-low-density polyethylene (VLDPE); polypropylene; copolymerized polypropylene; ethylene-vinyl acetate copolymer; and ethylene-(meth)acrylate (methyl ester or ethyl ester) copolymer. On the other hand, when a multilayer structure is produced by a dry laminating method, a polyurethane-based two-component curable adhesive is more preferable. In this case, since various polymers can be used for the x layer, the function of the multilayer structure can be more improved.

Examples of a method for preparing the multilayer structure include extrusion lamination, dry lamination, co-injection molding and co-extrusion molding. Examples of co-extrusion molding include co-extrusion lamination, co-extrusion sheet molding, co-extrusion pipe molding, co-extrusion tube molding, co-extrusion inflation molding, and co-extrusion blow molding.

A sheet, film, parison, or the like of the multilayer structure thus obtained are reheated at a temperature equal to or lower than the melting point of the contained polymer, and can be uniaxially or biaxially stretched by a thermoforming method including draw molding, roll stretching, pantograph stretching, inflation stretching, blow molding or the like to provide a stretched shaped article.

A shaped article containing a resin composition of the present invention thus obtained has excellent long run property and excellent color phase, and, particularly when it contains PA (D), further has excellent appearance after hot-water treatment such as retort treatment.

### EXAMPLES

There will be specifically described the present invention with reference to Examples and Comparative Examples, but the present invention is not limited to examples described below. Measurement, calculation and evaluation methods are in accordance with the following methods, respectively.

### Materials Used

[Divalent metal hydroxide (B)]
B-1: Magnesium hydroxide (FUJIFILM Wako Pure Chemical Corporation, aspect ratio: 10)
B-2: Magnesium hydroxide (FUJIFILM Wako Pure Chemical Corporation, aspect ratio: 23)
B-3: Magnesium hydroxide (FUJIFILM Wako Pure Chemical Corporation, powder)
B-4: KISUMA® 10 Å (Kyowa Chemical Industry Co., Ltd., magnesium hydroxide, aspect ratio: 67)
B-5: KISUMA® 5A (Kyowa Chemical Industry Co., Ltd., magnesium hydroxide, aspect ratio: 4)
B-6: Calcium hydroxide (FUJIFILM Wako Pure Chemical Corporation)
B-7: Zinc hydroxide (Junsei Chemical Co., Ltd.)

[Metal compound (B′)]
B′-8: Aluminum hydroxide (FUJIFILM Wako Pure Chemical Corporation)
B′-9: Magnesium acetate (FUJIFILM Wako Pure Chemical Corporation)
B′-10: Magnesium stearate (FUJIFILM Wako Pure Chemical Corporation)

An aspect ratio described in the divalent metal hydroxide (B) and the metal compound (B′) was determined from an arithmetic mean of measured values of a primary particle width (major axis) and a primary particle thickness (minor axis) of any 100 crystals in an SEM photograph by an SEM method.

[Monovalent metal compound (C)]
C-1: Sodium acetate
C-2: Potassium acetate

[Polyamide (D)]
D-1: Nylon 6 (Ube Industries, Ltd.)

[Carboxylic acid]
Lower fatty acid: Acetic acid
Higher fatty acid: Stearic acid

[Phosphate compound]
Phosphoric acid

<Evaluation method 1>(1-1) Quantification of metal atoms and phosphorus

To a Teflon® pressure proof container from Actac Co. Ltd. was added 0.5 g of resin composition pellets obtained in Examples 1-1 to 1-18 and Comparative Examples 1-1 to 1-7, and 5 mL of precision analysis grade nitric acid from FUJIFILM Wako Pure Chemical Corporation was added. After leaving it for 30 min, the container was covered with a cap lip equipped with a rupture disk, and then, decomposition was conducted by a microwave high-speed decomposition system “Speedwave MWS-2” from Actac Co., Ltd. at 150° C. for 10 min, then at 180° C. for 10 min. When decomposition of the resin composition pellets was insufficient, processing conditions were adjusted as appropriate. The content after decomposition was diluted with 10 mL of ion-exchange water, the whole solution was transferred to a 50 mL volumetric flask, and was made up constant volume with ion-exchange water, to prepare a decomposition solution. The decomposition solution was subjected to measurement by ICP emission spectrophotometer “Optima 4300 DV” from Perkin Elmer Japan Co., Ltd., to quantify the amount in terms of metal atoms for each metal compound and a content in terms of phosphorous atoms in phosphate compound.

### (1-2) Quantification of a Carboxylic Acid

10 g of resin composition pellets obtained Examples 1-1 to 1-18 and Comparative Examples 1-1 to 1-7 and 50 mL of pure water were charged into a 100 mL Erlenmeyer flask with a common plug, and after a reflux condenser was mounted, the mixture was stirred at 95° C. for 8 hours, to provide an extract. The extract obtained was cooled to 20° C., and then was titrated with a 0.02 mol/L aqueous solution of sodium hydroxide using phenolphthalein as an indicator to estimate acid amount. A carboxylic acid equivalent was calculated by subtracting the acid amount derived from the phosphate compound quantified above from the acid amount obtained, and the amount of the carboxylic acid contained in the resin composition was quantified from a molecular weight of the carboxylic acid used.

### (1-3) Evaluation of Long Run Property

Using resin composition pellets obtained in Examples 1-1 to 1-18 and Comparative Examples 1-1 to 1-7, a monolayer film with a thickness of 20 μm was continuously formed using a single screw extruder (Toyo Seiki Seisaku-sho, Ltd., D2020, D(mm)=20, L/D=20, compression ratio=3.5, screw: full flighted). The extrusion conditions are as follows.
Extrusion temperature: 210° C.
Die width: 30 cm
Take-up roll temperature: 80° C.
Screw speed: 40 rpm
Take-up roll speed: 3.1 m/min

Monolayer films formed 30 min and 8 hours after initiation of film forming were sampled in a size of 10 cm×10 cm, and visually observable hard spots (about 50 μm or more) were counted. Using the following equation, an increase rate of gelatinous hard spots was estimated, and evaluated in accordance with the following criteria. Of the following criteria, A, B and C are at a usable level.

Increase ratio of gelatinous hard spots=(the number of gelatinous hard spots in a 10 cm² area of the monolayer film obtained 8 hours after initiation of film forming)/(the number of gelatinous hard spots in a 10 cm² area of the monolayer film obtained 30 min after initiation of film forming)
Rank: criteria
A: Increase ratio of gelatinous hard spots is less than 2;
B: Increase ratio of gelatinous hard spots is 2 or more and less than 4;
C: Increase ratio of gelatinous hard spots is 4 or more and less than 6;
D: Increase ratio of gelatinous hard spots is 6 or more and less than 8;
E: Increase ratio of gelatinous hard spots is 8 or more.

### (1-4) Color Phase

Using resin composition pellets obtained in Examples 1-1 to 1-18 and Comparative Examples 1-1 to 1-7, a monolayer film with a thickness of 20 μm was formed by the film-forming method as described in the above evaluation method “(1-3) Evaluation of long run property”, and winded the film 1 hour after initiation of film forming by 20 m to a paper core with a diameter of 9 cm. YI value (Yl₁) at the center in the width direction of the winding roll and YI value (Yl₂) at the position of 3 cm from the film end were determined using a colorimeter NF-902 (Nippon Denshoku Industries Co., Ltd.) in accordance with the method described in JIS K 7373 to calculate YI ratio of the end to the center of the film using the equation below, and evaluated in accordance with the criteria below. Of the following criteria, A, B and C are at a usable level.
YI ratio=(Yl₂−Yl₁)/Yl₁

Rank: Criteria
A: YI ratio is less than 1.0;
B: YI ratio is 1.0 or more and less than 1.5;
C: YI ratio is 1.5 or more and less than 2.0;
D: YI ratio is 2.0 or more and less than 2.5;
E: YI ratio is 2.5 or more.

### (1-5) Oxygen Transmission Rate (OTR)

Using resin composition pellets obtained in Examples 1-1 to 1-18 and Comparative Examples 1-1 to 1-7, a monolayer film with a thickness of 20 μm was formed by the film-forming method as described in the above evaluation method “(1-3) Evaluation of long run property”, and the monolayer film obtained was subjected to measurement using an oxygen permeability testing system “type OX-TRAN2/20” (detection limit: 0.01 cc·20 μm/(m²·day·atm)) from MOCON INC. under the condition of temperature: 20° C. and humidity: 85% RH in accordance with the method described in JIS K 7126 (equal-pressure method). Oxygen barrier property was determined in accordance with the following criteria. Of the following criteria, A, B and C are at a usable level.

Criteria
A: less than 1.1
B: 1.1 or more and less than 1.3
C: 1.3 or more and less than 1.5
D: 1.5 or more

(Unit: cc·20 μm/m²·day·atm)

### Example 1-1

Hydrous EVOH pellets with an ethylene unit content of 27 mol % and a saponification degree of 99.9 mol % were added to an aqueous solution containing acetic acid and a monovalent metal compound (C-1) (sodium acetate), and were immersed at 25° C. for 6 hours with stirring. The pellets were deliquored, dried at 80° C. for 4 hours using a hot-air dryer (Yamato Scientific Co., Ltd., “DN6101”), and then dried at 120° C. for 40 hours, to give dried EVOH pellet (moisture content: 0.25%). Concentrations of acetic acid and the monovalent metal compound (C-1) in an aqueous solution containing acetic acid and the monovalent metal compound (C-1) were appropriately adjusted such that their contents in resin composition pellets 1-1 obtained in this example are as described in Table 1.

To the dried EVOH pellets thus obtained were dry-blended 24 ppm of a divalent metal hydroxide (B-1) (FUJIFILM Wako Pure Chemical Corporation, magnesium hydroxide) and 1.2 ppm of stearic acid, and then melt extrusion was conducted under the conditions of melting temperature: 210° C. and extrusion speed: 20 kg/hr using a twin-screw extruder “TEX30 α” (screw diameter: 30 mm) from The Japan Steel Works, Ltd. The extruded strand obtained was solidified by cooling in a cooling bath and then cut, to give resin composition pellets 1-1. Here, a sequential kneading disk (Forward kneading disk) with L (screw length)/D (screw diameter)=3 was used. The resin composition pellets 1-1 were a resin composition containing EVOH (A-1) which is EVOH with an ethylene unit content of 27 mol % and a saponification degree of 99.9 mol % the divalent metal hydroxide (B-1), the monovalent metal compound (C-1), acetic acid; and stearic acid, and the resin composition pellets 1-1 obtained had a moisture content of 0.20% and a melt flow rate of 3.9 g/10 min at 210° C. under a load of 2160 g.

A quantity of metal atoms, a quantity of the carboxylic acid, evaluation of long run property, color phase and an oxygen transmission rate were measured for the resin composition pellets 1-1 in accordance with the methods described in the above evaluation methods “(1-1) to (1-5)”. As for results of a quantity of the carboxylic acid, the value calculated from the amount of the carboxylic acid used as a raw material was taken into consideration. The results are shown in Table 1.

<Examples 1-2 to 1-18, Comparative Examples 1-2 to 1-7>

As shown in Table 1, Example resin composition pellets 1-2 to 1-18 and Comparative Example resin composition pellets C1-2 to C1-7 were prepared and evaluated as described in Example 1, except that the type and a content of the divalent metal hydroxide (B), a content of the monovalent metal compound (C), a content of the carboxylic acid and a content of phosphoric acid were changed. Phosphoric acid was introduced by blending phosphoric acid with a solution for immersing hydrous EVOH pellets. The evaluation results are shown in Table 1. Here, Example 1-18 containing phosphoric acid was particularly superior in color phase to Example 1-8 free from phosphoric acid.

### Comparative Example 1-1

Hydrous EVOH pellets with an ethylene unit content of 27 mol % and a saponification degree of 99.9 mol % were added to an aqueous solution containing acetic acid and a monovalent metal salt (C-1), and were immersed at 25° C. for 6 hours with stirring. The pellets were deliquored, dried at 80° C. for 4 hours using a hot-air dryer (Yamato Scientific Co., Ltd., “DN6101”), and then dried at 120° C. for 40 hours, to give dried EVOH pellet (moisture content: 0.25%). Concentrations of acetic acid and the monovalent metal salt (C-1) in an aqueous solution containing acetic acid and the monovalent metal salt (C-1) were appropriately adjusted such that their contents in resin composition pellets C1-1 obtained in this comparative example are as described in Table 1.

To the dried EVOH pellets thus obtained was dry-blended 1.2 ppm of stearic acid, and then melt extrusion was conducted under the conditions of melting temperature: 210° C. and extrusion speed: 20 kg/hr using a twin-screw extruder “TEX30 α” (screw diameter: 30 mm) from The Japan Steel Works, Ltd. Further, an aqueous solution of a metal compound (B′-9) prepared in a twin-screw extruder was added using a liquid addition pump such that a metal concentration in the resin composition pellets C1-1 is a concentration described in Table 1. The extruded strand was solidified by cooling in a cooling bath and then cut, to give resin composition pellets C1-1. A screw having a structure in which a sequential kneading disk (Forward kneading disk) having a L (screw length)/D (screw diameter)=3 is arranged at a downstream side of the liquid addition pump was used. The resin composition pellets C1-1 were a resin composition containing EVOH (A-1) which is EVOH with an ethylene unit content of 27 mol % and a saponification degree of 99.9 mol % the divalent metal compound (B′-9); the monovalent metal compound (C-1), acetic acid; and stearic acid, and the resin composition pellets C1-1 obtained had a moisture content of 0.20% and a melt flow rate of 3.9 g/10 min at 210° C. under a load of 2160 g. The resin composition pellets C1-1 thus obtained were evaluated as described in Example 1. The results are shown in Table 1.

### Evaluation Method 2

(2-1) Long run property evaluation

Using resin composition pellets obtained in Examples 2-1 to 2-21 and Comparative Examples 2-1 to 2-6, a monolayer film with a thickness of 20 μm was continuously formed using a single screw extruder (Toyo Seiki Seisaku-sho, Ltd., D2020, D(mm)=20, L/D=20, compression ratio=3.5, screw: full flighted). The extrusion conditions are as follows.
Extrusion temperature: 230° C.
Die width: 30 cm
Take-up roll temperature: 80° C.
Screw speed: 40 rpm
Take-up roll speed: 3.1 m/min

Monolayer films formed 30 min and 4 hours after initiation of film forming were sampled in a size of 10 cm×10 cm, and visually observable hard spots (about 50 μm or more) were counted. Using the following equation, an increase ratio of hard spots was estimated, and evaluated in accordance with the following criteria. Of the following criteria, A, B and C are at a usable level.

Increase ratio of hard spots=(the number of hard spots in a 10 cm² area of the monolayer film obtained 4 hours after initiation of film forming)/(the number of hard spots in a 10 cm² area of the monolayer film obtained 30 min after initiation of film forming)
Rank: criteria
A: Increase ratio of hard spots is less than 2;
B: Increase ratio of hard spots is 2 or more and less than 4;
C: Increase ratio of hard spots is 4 or more and less than 6;
D: Increase ratio of hard spots is 6 or more and less than 8;
E: Increase ratio of hard spots is 8 or more.

### (2-2) Color Phase

Using resin composition pellets obtained in Examples 2-1 to 2-21 and Comparative Examples 2-1 to 2-6, a monolayer film with a thickness of 20 μm was formed by the film-forming method as described in the above evaluation method “(2-1) Evaluation of long run property”, and winded the film 1 hour after initiation of film forming by 20 m to a paper core with a diameter of 9 cm. A YI value (Yl₁) at the center in the width direction of the winding roll and a YI value (Yl₂) at the position of 3 cm from the film end were determined using a colorimeter NF-902 (Nippon Denshoku Industries Co., Ltd.) in accordance with the method described in JIS K 7373 to calculate a YI ratio of the end to the center of the film using the equation below, and evaluated in accordance with the criteria below. Of the following criteria, A, B and C are at a usable level.
YI ratio=(Yl₂−Yl₁)/Yl₁

Rank: Criteria

A: YI ratio is less than 1.0;
B: YI ratio is 1.0 or more and less than 1.5;
C: YI ratio is 1.5 or more and less than 2.0;
D: YI ratio is 2.0 or more and less than 2.5;
E: YI ratio is 2.5 or more.

### (2-3) Retort resistance

Using resin composition pellets obtained in Examples 2-1 to 2-21 and Comparative Examples 2-1 to 2-6, a monolayer film with a thickness of 20 μm was formed by the film-forming method as described in the above evaluation method “(2-1) Evaluation of long run property”, and each of the monolayer film obtained, a biaxially stretched Nylon-6 film (Unitika Ltd., “EMBLEM ONBC”, thickness: 15 μm) and an unstretched polypropylene film (Mitsui Chemicals Tohcello, Inc., “RXC-22”, thickness: 50 μm) was cut into an A4 size. To both sides of the monolayer film was applied an adhesive for dry lamination, and dry lamination was conducted such that the outer layer was a Nylon 6 film and the inner layer was a non-stretched polypropylene film, and then dried at 80° C. for 3 min, to give a transparent three-layer laminated film. The adhesive for dry lamination was an adhesive in which a main agent was “Takelac A-520” from Mitsui Chemicals Inc., a hardener was “Takenate A-50” from Mitsui Chemicals Inc., and a diluent was ethyl acetate. The application amount of the adhesive was 4.0 g/m², and after lamination, it was cured at 40° C. for 3 days.

Using the two laminated films thus obtained, a pouch having outer dimension 12 cm×12 cm whose all sides were sealed was prepared. The content was water. This was retort-treated at 120° C. for 120 min, using a retort apparatus (high temperature and high pressure cooking sterilization tester “RCS-4ORTGN” from Hisaka Works, Ltd.). After the retort treatment, surface water was wiped off and the pouch was left in a thermohygrostatic chamber at 20° C. and 65% RH for 1 day, and then, for evaluation of retort resistance, an appearance property was determined in accordance with the following criteria. Of the following criteria, A is a usable level.

Rank: criteria
A: No whitening
B: Streak-like whitening
C: About 25% of the pouch surface is whitened
D: Half of the pouch surface is whitened
E: Almost the entire surface of the pouch is whitened

### (2-4) Oxygen Transmission Rate (OTR)

Using resin composition pellets obtained in Examples 2-1 to 2-21 and Comparative Examples 2-1 to 2-6, a monolayer film with a thickness of 20 μm was formed by the film-forming method as described in the above evaluation method “(2-1) Evaluation of long run property”, and the monolayer film obtained was subjected to measurement using an oxygen permeability testing system “type OX-TRAN2/20” (detection limit: 0.01 cc·20 μm/(m²·day·atm)) from MOCON INC. under the condition of temperature: 20° C. and humidity: 85% RH in accordance with the method described in JIS K 7126 (isopressure method).

Oxygen barrier property was determined in accordance with the following criteria. Of the following criteria, A, B and C are at a usable level.

Criteria
A: less than 2.1
B: 2.1 or more and less than 2.3
C: 2.3 or more and less than 2.5
D: 2.5 or more

(Unit: cc·20 μm/m²·day·atm)

### (2-5) Average Dispersed Particle Size

Resin composition pellets of each Example or Comparative Example were embedded in an epoxy resin and were cut by an ultramicrotome to prepare a transverse section. The transverse section thus prepared was electron-stained in a 5% aqueous solution of phosphotungstic acid for 3 min, dried and then observed at 20,000x observation magnification using JEPL Ltd. In the observation, an average particle size was measured for 100 PA particles and an average thereof was calculated as an average dispersed particle size. In the observation with a TEM, EVOH was observed as a light contrast part in a photograph while PA was observed as a dark contrast part.

### Example 2-1

Hydrous EVOH pellets with an ethylene unit content of 27 mol % and a saponification degree of 99.9 mol % were added to an aqueous solution containing acetic acid and a monovalent metal compound (C-1) (sodium acetate), and were immersed at 25° C. for 6 hours with stirring. The pellets were deliquored, dried at 80° C. for 4 hours using a hot-air dryer (Yamato Scientific Co., Ltd., DN6101), and then dried at 120° C. for 40 hours, to give dried EVOH pellet (moisture content: 0.25%). Concentrations of acetic acid and the monovalent metal compound (C-1) in an aqueous solution containing acetic acid and the monovalent metal compound (C-1) were appropriately adjusted such that their contents in resin composition pellets 2-1 obtained in this example are as described in Table 2.

To 90 parts by mass of the dried EVOH pellets thus obtained and 10 parts by mass of PA (D-1) (UBE NYLON SF1018A), that is, the total 100 parts by mass, were added 108 ppm of a divalent metal hydroxide (B-1) (magnesium hydroxide, aspect ratio: 10) and 5.5 ppm of stearic acid, and the mixture was dry-blended, and then melt extrusion was conducted under the conditions of melting temperature: 230° C. and extrusion speed: 20 kg/hr using a twin-screw extruder “TEX30 a” (screw diameter: 30 mm) from The Japan Steel Works, Ltd.

The extruded strand obtained was solidified by cooling in a cooling bath and then cut, to give resin composition pellets 2-1. Here, a screw of the extruder used was a sequential kneading disk (Forward kneading disk) with L (screw length)/D (screw diameter)=3 was used. The resin composition pellets 2-1 were a resin composition containing EVOH (A-1) which is EVOH with an ethylene unit content of 27 mol % and a saponification degree of 99.9 mol %; PA (D-1); the divalent metal hydroxide (B-1); the monovalent metal compound (C-1); acetic acid; and stearic acid, and the resin composition pellets 2-1 had a moisture content of 0.20% and a melt flow rate of 6.0 g/10 min at 230° C. under a load of 2160 g.

The resin composition pellets 2-1 obtained were evaluated for a quantity of metal atoms, a quantity of the carboxylic acid, evaluation of long run property, color phase, retort resistance and an oxygen transmission rate in accordance with the methods described in the above evaluation methods “(1-1), (1-2), (2-1) to (2-4)”. As for results of a quantity of the carboxylic acid, the value calculated from the amount of the carboxylic acid used as a raw material was taken into consideration. The results are shown in Table 2.

### Examples 2-2 to 2-21, Comparative Examples 2-2 to 2-6

As shown in Table 2, Example resin composition pellets 2-2 to 2-21 and Comparative Example resin composition pellets C2-1 to C2-6 were prepared and evaluated as described in Example 2-1, except that a content of PA (D), the type and a content of the divalent metal hydroxide (B), the type and a content of the monovalent metal compound (C), a content of the carboxylic acid and a content of phosphoric acid were changed. Phosphoric acid was introduced by blending phosphoric acid with a solution for immersing hydrous EVOH pellets. The evaluation results are shown in Table 2. Here, Example 2-20 containing phosphoric acid was particularly superior in color phase to Example 2-6 free from phosphoric acid. Examples 2-21 and 2-10 were evaluated as follows.

(Evaluation)

The pouch retort-treated in accordance with the evaluation method “(2-3) evaluation of retort resistance” was opened, and cut into a size 5 cm×7 cm. The cut sample was determined for haze in accordance with JIS K 7105, using a reflection/transmittance meter (“HR-100” from Murakami Color Research Laboratory Co., Ltd.).

As a result of the evaluation, it was determined that Example 2-21 with a high polyamide content had a haze value of 21.5, Example 2-10 had a haze value of 23.6, and Example 2-21 with a high polyamide content exhibited excellent transparency.

TABLE 1

| | | Divalent metal hydroxide (B) | | | | | Monovalent | Monovalent | | |
|---|---|---|---|---|---|---|---|---|---|---|
| | | | | Divalent metal | | | metal | metal | | |
| | EVOH | | | atom | | | compound | atom | | Mass |
| | (A) | | Content | | Content | Aspect | (C) | | Content | ratio |
| | Type | Type | ppm | Type | ppm | ratio | Type | Type | ppm | C/B |
| Example 1-1 | A-1 | B-1 | 24 | Mg | 10 | 10 | C-1 | Na | 150 | 15 |
| Example 1-2 | A-1 | B-1 | 24 | Mg | 10 | 10 | C-1 | Na | 150 | 15 |
| Example 1-3 | A-1 | B-6 | 18 | Ca | 10 | 4 | C-1 | Na | 150 | 15 |
| Example 1-4 | A-1 | B-7 | 15 | Zn | 10 | 13 | C-1 | Na | 150 | 15 |
| Example 1-5 | A-1 | B-2 | 24 | Mg | 10 | 23 | C-1 | Na | 150 | 15 |
| Example 1-6 | A-1 | B-2 | 24 | Mg | 10 | 23 | C-1 | Na | 150 | 15 |
| Example 1-7 | A-1 | B-3 | 24 | Mg | 10 | — | C-1 | Na | 150 | 15 |
| Example 1-8 | A-1 | B-4 | 24 | Mg | 10 | 67 | C-1 | Na | 150 | 15 |
| Example 1-9 | A-1 | B-5 | 24 | Mg | 10 | 4 | C-1 | Na | 150 | 15 |
| Example | A-1 | B-4 | 10 | Mg | 4 | 67 | C-1 | Na | 150 | 37.5 |
| 1-10 | | | | | | | | | | |
| Example | A-1 | B-4 | 2879 | Mg | 1200 | 67 | C-1 | Na | 150 | 0.13 |
| 1-11 | | | | | | | | | | |
| Example | A-1 | B-4 | 1200 | Mg | 500 | 67 | C-1 | Na | 150 | 0.3 |
| 1-12 | | | | | | | | | | |
| Example | A-1 | B-4 | 24 | Mg | 10 | 67 | C-1 | Na | 400 | 40 |
| 1-13 | | | | | | | | | | |
| Example | A-1 | B-4 | 24 | Mg | 10 | 67 | C-1 | Na | 10 | 1 |
| 1-14 | | | | | | | | | | |
| Example | A-1 | B-4 | 24 | Mg | 10 | 67 | C-2 | K | 150 | 15 |
| 1-15 | | | | | | | | | | |
| Example | A-1 | B-4 | 24 | Mg | 10 | 67 | C-1 | Na | 150 | 15 |
| 1-16 | | | | | | | | | | |
| Example | A-1 | B-4 | 24 | Mg | 10 | 67 | C-1 | Na | 150 | 15 |
| 1-17 | | | | | | | | | | |
| Example | A-1 | B-4 | 24 | Mg | 10 | 67 | C-1 | Na | 150 | 15 |
| 1-18 | | | | | | | | | | |
| Comparative | A-1 | B′-9 | 59 | Mg | 10 | — | C-1 | Na | 150 | 15 |
| Example 1-1 | | | | | | | | | | |
| Comparative | A-1 | B′-10 | 243 | Mg | 10 | — | C-1 | Na | 150 | 15 |
| Example 1-2 | | | | | | | | | | |
| Comparative | A-1 | — | — | — | — | — | C-1 | Na | 150 | — |
| Example 1-3 | | | | | | | | | | |
| Comparative | A-1 | B-4 | 5759 | Mg | 2400 | 67 | C-1 | Na | 150 | 0.0625 |
| Example 1-4 | | | | | | | | | | |
| Comparative | A-1 | B′-8 | 29 | Al | 10 | 2 | C-1 | Na | 150 | 15 |
| Example 1-5 | | | | | | | | | | |
| Comparative | A-1 | B-4 | 24 | Mg | 10 | 67 | — | — | — | — |
| Example 1-6 | | | | | | | | | | |
| Comparative | A-1 | B-4 | 10 | Mg | 4 | 67 | C-1 | Na | 500 | 125 |
| Example 1-7 | | | | | | | | | | |

| | Carboxylic acid | | | | | | | |
|---|---|---|---|---|---|---|---|---|
| | Lower fatty | | Higher fatty | | Phosphoric | | | |
| | acid | | acid | | acid | | | Oxygen |
| | | Content | | Content | Content | Color | Long run | perme- |
| | Type | ppm | Type | ppm | ppm | phase | property | ability |
| Example 1-1 | Acetic | 100 | Stearic | 1.2 | — | A | A | B |
| | acid | | acid | | | | | |
| Example 1-2 | Acetic | 100 | — | — | — | B | A | B |
| | acid | | | | | | | |
| Example 1-3 | Acetic | 100 | Stearic | 1.2 | — | A | B | C |
| | acid | | acid | | | | | |
| Example 1-4 | Acetic | 100 | Stearic | 1.2 | — | A | B | B |
| | acid | | acid | | | | | |
| Example 1-5 | Acetic | 100 | Stearic | 1.2 | — | A | A | B |
| | acid | | acid | | | | | |
| Example 1-6 | Acetic | 100 | — | — | — | B | A | B |
| | acid | | | | | | | |
| Example 1-7 | Acetic | 100 | Stearic | 1.2 | — | A | A | C |
| | acid | | acid | | | | | |
| Example 1-8 | Acetic | 100 | Stearic | 1.2 | — | A | A | A |
| | acid | | acid | | | | | |
| Example 1-9 | Acetic | 100 | Stearic | 1.2 | — | A | A | C |
| | acid | | acid | | | | | |
| Example | Acetic | 100 | Stearic | 0.5 | — | A | B | A |
| 1-10 | acid | | acid | | | | | |
| Example | Acetic | 100 | Stearic | 145 | — | C | A | A |
| 1-11 | acid | | acid | | | | | |
| Example | Acetic | 100 | Stearic | 60 | — | B | A | A |
| 1-12 | acid | | acid | | | | | |
| Example | Acetic | 100 | Stearic | 1.2 | — | C | A | A |
| 1-13 | acid | | acid | | | | | |
| Example | Acetic | 100 | Stearic | 1.2 | — | A | B | A |
| 1-14 | acid | | acid | | | | | |
| Example | Acetic | 100 | Stearic | 1.2 | — | A | C | A |
| 1-15 | acid | | acid | | | | | |
| Example | Acetic | 20 | Stearic | 1.2 | — | C | A | A |
| 1-16 | acid | | acid | | | | | |
| Example | Acetic | 300 | Stearic | 1.2 | — | A | C | A |
| 1-17 | acid | | acid | | | | | |
| Example | Acetic | 100 | Stearic | 1.2 | 100 | A | A | A |
| 1-18 | acid | | acid | | | | | |
| Comparative | Acetic | 100 | Stearic | 1.2 | — | D | A | D |
| Example 1-1 | acid | | acid | | | | | |
| Comparative | Acetic | 100 | Stearic | 240 | — | A | D | D |
| Example 1-2 | acid | | acid | | | | | |
| Comparative | Acetic | 100 | — | — | — | A | D | D |
| Example 1-3 | acid | | | | | | | |
| Comparative | Acetic | 100 | Stearic | 290 | — | E | A | A |
| Example 1-4 | acid | | acid | | | | | |
| Comparative | Acetic | 100 | Stearic | 1.5 | — | A | E | C |
| Example 1-5 | acid | | acid | | | | | |
| Comparative | Acetic | 100 | Stearic | 1.2 | — | A | D | A |
| Example 1-6 | acid | | acid | | | | | |
| Comparative | Acetic | 100 | Stearic | 1.2 | — | E | A | A |
| Example 1-7 | acid | | acid | | | | | |

TABLE 2

| | | | | | Divalent metal hydroxide (B) | | | | | | | | |
|---|---|---|---|---|---|---|---|---|---|---|---|---|---|
| | | | | | | | Divalent | | | Monovalent | Monovalent | | |
| | EVOH (A) | | PA (D) | | | | metal | | | metal | metal | | |
| | | Content | | Content | | | atom | | | compound | atom | | Mass |
| | | Parts by | | Parts by | | Content | | Content | Aspect | (C) | | Content | ratio |
| | Type | mass | Type | mass | Type | ppm | Type | ppm | ratio | Type | Type | ppm | C/B |
| Example 2-1 | A-1 | 90 | D-1 | 10 | B-1 | 108 | Mg | 45 | 10 | C-1 | Na | 150 | 3.3 |
| Example 2-2 | A-1 | 90 | D-1 | 10 | B-1 | 108 | Mg | 45 | 10 | C-1 | Na | 150 | 3.3 |
| Example 2-3 | A-1 | 90 | D-1 | 10 | B-6 | 137 | Ca | 45 | 4 | C-1 | Na | 150 | 3.3 |
| Example 2-4 | A-1 | 90 | D-1 | 10 | B-7 | 184 | Zn | 45 | 13 | C-1 | Na | 150 | 3.3 |
| Example 2-5 | A-1 | 90 | D-1 | 10 | B-2 | 108 | Mg | 45 | 23 | C-1 | Na | 150 | 3.3 |
| Example 2-6 | A-1 | 90 | D-1 | 10 | B-2 | 108 | Mg | 45 | 23 | C-1 | Na | 150 | 3.3 |
| Example 2-7 | A-1 | 90 | D-1 | 10 | B-3 | 108 | Mg | 45 | — | C-1 | Na | 150 | 3.3 |
| Example 2-8 | A-1 | 90 | D-1 | 10 | B-4 | 108 | Mg | 45 | 67 | C-1 | Na | 150 | 3.3 |
| Example 2-9 | A-1 | 90 | D-1 | 10 | B-5 | 108 | Mg | 45 | 4 | C-1 | Na | 150 | 3.3 |
| Example | A-1 | 90 | D-1 | 10 | B-4 | 48 | Mg | 20 | 67 | C-1 | Na | 150 | 7.5 |
| 2-10 | | | | | | | | | | | | | |
| Example | A-1 | 90 | D-1 | 10 | B-4 | 2879 | Mg | 1200 | 67 | C-1 | Na | 150 | 0.1 |
| 2-11 | | | | | | | | | | | | | |
| Example | A-1 | 90 | D-1 | 10 | B-4 | 1200 | Mg | 500 | 67 | C-1 | Na | 150 | 0.3 |
| 2-12 | | | | | | | | | | | | | |
| Example | A-1 | 90 | D-1 | 10 | B-4 | 108 | Mg | 45 | 67 | C-1 | Na | 1500 | 33.3 |
| 2-13 | | | | | | | | | | | | | |
| Example | A-1 | 90 | D-1 | 10 | B-4 | 108 | Mg | 45 | 67 | C-1 | Na | 800 | 17.8 |
| 2-14 | | | | | | | | | | | | | |
| Example | A-1 | 90 | D-1 | 10 | B-4 | 108 | Mg | 45 | 67 | C-1 | Na | 500 | 11.1 |
| 2-15 | | | | | | | | | | | | | |
| Example | A-1 | 90 | D-1 | 10 | B-4 | 108 | Mg | 45 | 67 | C-1 | Na | 10 | 0.2 |
| 2-16 | | | | | | | | | | | | | |
| Example | A-1 | 90 | D-1 | 10 | B-4 | 108 | Mg | 45 | 67 | C-2 | K | 150 | 3.3 |
| 2-17 | | | | | | | | | | | | | |
| Example | A-1 | 90 | D-1 | 10 | B-4 | 108 | Mg | 45 | 67 | C-1 | Na | 150 | 3.3 |
| 2-18 | | | | | | | | | | | | | |
| Example | A-1 | 90 | D-1 | 10 | B-4 | 108 | Mg | 45 | 67 | C-1 | Na | 150 | 3.3 |
| 2-19 | | | | | | | | | | | | | |
| Example | A-1 | 90 | D-1 | 10 | B-4 | 108 | Mg | 45 | 67 | C-1 | Na | 150 | 3.3 |
| 2-20 | | | | | | | | | | | | | |
| Example | A-1 | 80 | D-1 | 20 | B-4 | 480 | Mg | 200 | 67 | C-1 | Na | 150 | 0.8 |
| 2-21 | | | | | | | | | | | | | |
| Comparative | A-1 | 90 | D-1 | 10 | B′-10 | 1095 | Mg | 45 | — | C-1 | Na | 150 | 3.3 |
| Example 2-1 | | | | | | | | | | | | | |
| Comparative | A-1 | 90 | D-1 | 10 | — | — | — | — | — | C-1 | Na | 150 | — |
| Example 2-2 | | | | | | | | | | | | | |
| Comparative | A-1 | 90 | D-1 | 10 | B-4 | 5759 | Mg | 2400 | 67 | C-1 | Na | 150 | 0.06 |
| Example 2-3 | | | | | | | | | | | | | |
| Comparative | A-1 | 90 | D-1 | 10 | B′-8 | 144 | Al | 45 | 2 | C-1 | Na | 150 | 3.3 |
| Example 2-4 | | | | | | | | | | | | | |
| Comparative | A-1 | 90 | D-1 | 10 | B-4 | 48 | Mg | 20 | 67 | C-1 | Na | 2100 | 105 |
| Example 2-5 | | | | | | | | | | | | | |
| Comparative | A-1 | 90 | D-1 | 10 | B-4 | 48 | Mg | 20 | 67 | — | — | — | — |
| Example 2-6 | | | | | | | | | | | | | |

| | PA(D) | | | | | | | | | |
|---|---|---|---|---|---|---|---|---|---|---|
| | average | Carboxylic acid | | | | | | | | |
| | dispersed | Lower fatty | | Higher fatty | | Phosphoric | | | | |
| | particle | acid | | acid | | acid | | | Appearance | Oxygen |
| | size | | Content | | Content | Content | Color | Long run | after | perme- |
| | μm | Type | ppm | Type | ppm | ppm | phase | property | retorting | ability |
| Example 2-1 | 0.05 | Acetic | 100 | Stearic | 5.5 | — | A | A | A | B |
| | | acid | | acid | | | | | | |
| Example 2-2 | 0.05 | Acetic | 100 | — | — | — | B | A | A | B |
| | | acid | | | | | | | | |
| Example 2-3 | 0.05 | Acetic | 100 | Stearic | 7.0 | — | A | B | A | C |
| | | acid | | acid | | | | | | |
| Example 2-4 | 0.05 | Acetic | 100 | Stearic | 9.2 | — | A | C | A | B |
| | | acid | | acid | | | | | | |
| Example 2-5 | 0.05 | Acetic | 100 | Stearic | 5.5 | — | A | A | A | B |
| | | acid | | acid | | | | | | |
| Example 2-6 | 0.05 | Acetic | 100 | — | — | — | B | A | A | B |
| | | acid | | | | | | | | |
| Example 2-7 | 0.05 | Acetic | 100 | Stearic | 5.5 | — | A | A | A | C |
| | | acid | | acid | | | | | | |
| Example 2-8 | 0.05 | Acetic | 100 | Stearic | 5.5 | — | A | A | A | A |
| | | acid | | acid | | | | | | |
| Example 2-9 | 0.05 | Acetic | 100 | Stearic | 5.5 | — | A | A | A | C |
| | | acid | | acid | | | | | | |
| Example | 0.05 | Acetic | 100 | Stearic | 1.0 | — | A | B | A | A |
| 2-10 | | acid | | acid | | | | | | |
| Example | 0.05 | Acetic | 100 | Stearic | 145 | — | C | A | A | A |
| 2-11 | | acid | | acid | | | | | | |
| Example | 0.05 | Acetic | 100 | Stearic | 60 | — | B | A | A | A |
| 2-12 | | acid | | acid | | | | | | |
| Example | 0.05 | Acetic | 100 | Stearic | 5.5 | — | C | A | A | A |
| 2-13 | | acid | | acid | | | | | | |
| Example | 0.05 | Acetic | 100 | Stearic | 5.5 | — | B | A | A | A |
| 2-14 | | acid | | acid | | | | | | |
| Example | 0.05 | Acetic | 100 | Stearic | 5.5 | — | B | A | A | A |
| 2-15 | | acid | | acid | | | | | | |
| Example | 0.05 | Acetic | 100 | Stearic | 5.5 | — | A | C | A | A |
| 2-16 | | acid | | acid | | | | | | |
| Example | 0.05 | Acetic | 100 | Stearic | 5.5 | — | A | C | A | A |
| 2-17 | | acid | | acid | | | | | | |
| Example | 0.05 | Acetic | 20 | Stearic | 5.5 | — | C | A | A | A |
| 2-18 | | acid | | acid | | | | | | |
| Example | 0.05 | Acetic | 300 | Stearic | 5.5 | — | A | C | A | A |
| 2-19 | | acid | | acid | | | | | | |
| Example | 0.05 | Acetic | 100 | Stearic | 5.5 | 100 | A | A | A | A |
| 2-20 | | acid | | acid | | | | | | |
| Example | 0.05 | Acetic | 100 | Stearic | 5.5 | — | B | B | A | C |
| 2-21 | | acid | | acid | | | | | | |
| Comparative | 0.05 | Acetic | 100 | Stearic | 1050 | — | A | E | D | D |
| Example 2-1 | | acid | | acid | | | | | | |
| Comparative | 0.05 | Acetic | 100 | — | — | — | A | D | A | D |
| Example 2-2 | | acid | | | | | | | | |
| Comparative | 0.05 | Acetic | 100 | Stearic | 290 | — | E | A | A | A |
| Example 2-3 | | acid | | acid | | | | | | |
| Comparative | 0.05 | Acetic | 100 | Stearic | 7.2 | — | A | D | A | C |
| Example 2-4 | | acid | | acid | | | | | | |
| Comparative | 0.05 | Acetic | 100 | Stearic | 5.5 | — | E | A | A | A |
| Example 2-5 | | acid | | acid | | | | | | |
| Comparative | 0.05 | Acetic | 100 | Stearic | 5.5 | — | A | D | A | A |
| Example 2-6 | | acid | | acid | | | | | | |

1. A resin composition comprising an ethylene-vinyl alcohol copolymer (A) with an ethylene unit content of 20 mol % or more and 60 mol % or less, a divalent metal hydroxide (B) and a monovalent metal compound (C), wherein a content of the divalent metal hydroxide (B) is 5 ppm or more and 5000 ppm or less, and a mass ratio (C/B) of the amount of the monovalent metal compound (C) in terms of the monovalent metal atom to the amount of the divalent metal hydroxide (B) in terms of the divalent metal atom is 0.025 to 100.

2. The resin composition according to claim 1, further comprising a polyamide resin (D).

3. The resin composition according to claim 2, wherein a mass ratio (A/D) of the ethylene-vinyl alcohol copolymer (A) to the polyamide resin (D) is 55/45 to 99/1.

4. The resin composition according to claim 2, comprising a matrix phase containing the ethylene-vinyl alcohol copolymer (A) and a dispersion phase containing the polyamide resin (D), wherein an average dispersed particle size of the dispersion phase containing the polyamide resin (D) is 2 μm or less.

5. The resin composition according to claim 1, wherein the ethylene-vinyl alcohol copolymer (A) occupies 95% by mass or more of a thermoplastic resin constituting the resin composition, or the ethylene-vinyl alcohol copolymer (A) and the polyamide resin (D) occupy 95% by mass or more of a thermoplastic resin constituting the resin composition.

6. The resin composition according to claim 1, wherein a content of the monovalent metal compound (C) in terms of the monovalent metal atom is 5 ppm or more and 1000 ppm or less.

7. The resin composition according to claim 1, wherein the divalent metal atom constituting the divalent metal hydroxide (B) is at least one selected from the group consisting of magnesium, calcium, iron and zinc.

8. The resin composition according to claim 1, wherein a proportion of magnesium atoms in the total metal atoms constituting the divalent metal hydroxide (B) is 80 mol % or more.

9. The resin composition according to claim 1, wherein the monovalent metal atom constituting the monovalent metal compound (C) is at least one selected from the group consisting of sodium, potassium, lithium, rubidium and cesium.

10. The resin composition according to claim 1, further comprising a carboxylic acid.

11. The resin composition according to claim 10, wherein the resin composition comprises a higher fatty acid as the carboxylic acid, and a content of the higher fatty acid is 0.1 ppm or more and 250 ppm or less.

12. The resin composition according to claim 1, further comprising a phosphate compound.

13. The resin composition according to claim 1, wherein an aspect ratio of the divalent metal hydroxide (B) is 3 or more and 500 or less.

14. A shaped article comprising the resin composition according to claim 1.

15. A multilayer structure comprising a layer made of the resin composition according to claim 1.
